(19) United States
(12) Patent Application Publication
(10) Pub. No.: US 2015/0242312 A1
(43) Pub. Date: Aug. 27, 2015

(54) METHOD OF MANAGING MEMORY, COMPUTER, AND RECORDING MEDIUM

(71) Applicant: HITACHI, LTD., Chiyoda-ku, Tokyo (JP)

(72) Inventors: Kenichi Ideue, Tokyo (JP); Motoki Obata, Tokyo (JP); Hiroyasu Nishiyama, Tokyo (JP)

(21) Appl. No.: 14/424,052

(22) PCT Filed: Apr. 19, 2013
(86) PCT No.: PCT/JP2013/061567

§ 371 Date: Feb. 26, 2015

(51) Int. Cl. G06F 12/02; G06F 11/32; G06F 9/30

(52) U.S. Cl. CPC G06F 12/0253; G06F 9/3004; G06F 11/324; G06F 2212/702

(57) ABSTRACT

A memory use amount used by each object can be calculated for each of a plurality of pieces of generator property information that is information related to generation of data such as user information and request information. A computer for executing a program to generate data executes a step of specifying, from a storage device in which the plurality of pieces of generator property information on the data and identification information that the data has are associated and held, data corresponding to each piece of the generator property information and calculating a memory use amount of the specified data, and a step of outputting the calculated memory use amount to an interface. Further, a data structure of the data has a control area for storing information on control of the data and a data area, and the computer inserts the identification information into the data area.

### TECHNICAL FIELD

The present invention relates to a method of managing a memory, a computer, and a recording medium.

### BACKGROUND ART

Ina society in which IT has been introduced into business of companies as a business system, an application server that is a constituent element of a system is an essential element. The application server is generally realized by an execution environment such as Java (registered trademark) or .NET (registered trademark). In a case where the application server is operated, a memory use amount in the execution environment is an important item to be monitored. Therefore, a person in charge of operation of the system always monitors a memory use amount of an object and takes, as part of an operational service, measures against reduction in performance of the system, a system crash, and the like caused by memory tuning and the memory use amount.

PTL 1 discloses a method of classifying generated objects by application and calculating a memory use amount for each application by specifying to which application a shared object referred to by a plurality of applications belongs.

### CITATION LIST

### Patent Literature

PTL 1: JP-A-2012-221147

### SUMMARY OF INVENTION

### Technical Problems

However, the method described in PTL 1 is not suitable in a case where a plurality of users execute an application or for calculating, in a system in which many applications are executed in a single virtual machine, a memory use amount for each application or for each piece of information related to a generator of an object (hereinafter, referred to as “generator property information”) such as user information. In the method described in PTL 1, because data is stored in a header area having a fixed size depending on an execution environment, the number of manageable applications or the number of pieces of manageable generator property information is limited.

### Solution to Problems

A representative embodiment of the invention is such that a computer for executing a program to generate data executes a step of specifying, from a storage device in which a plurality of pieces of generator property information on the data and identification information that the data has are associated and held, data corresponding to each piece of the generator property information and calculating a memory use amount of the specified data, and a step of outputting the calculated memory use amount to an interface.

### Advantageous Effects of Invention

According to an aspect of the invention, it is possible to calculate a memory use amount used for each of a plurality of pieces of generator property information on data.

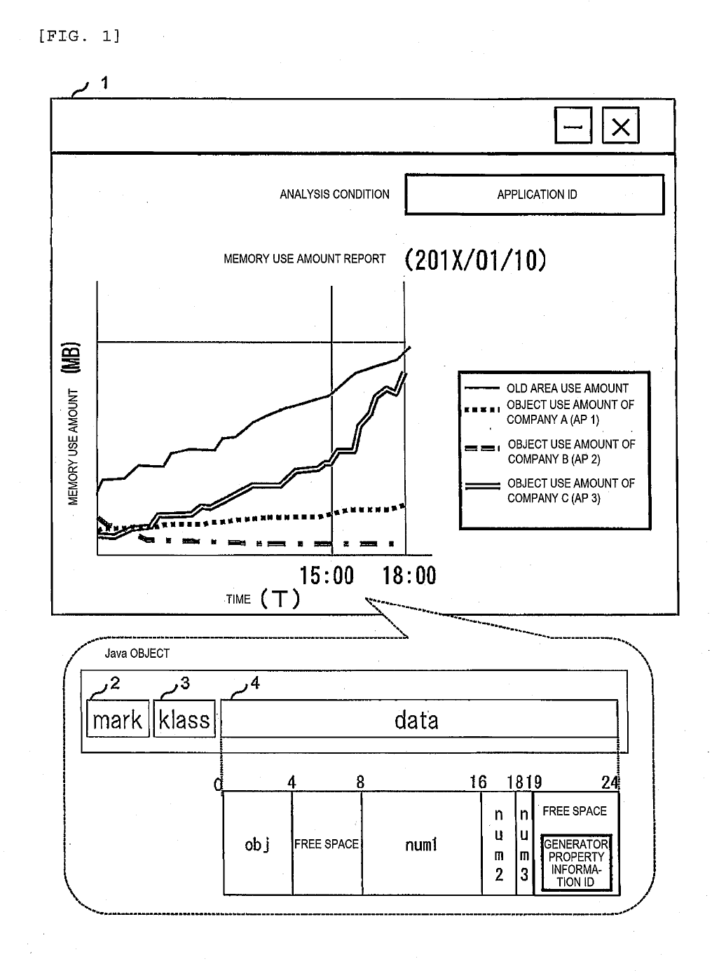

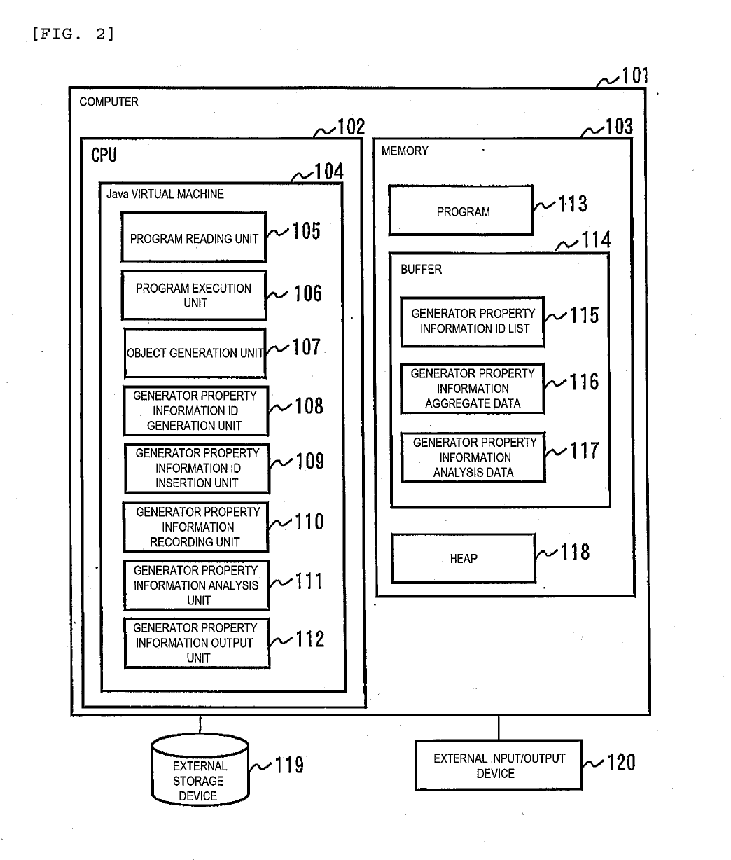

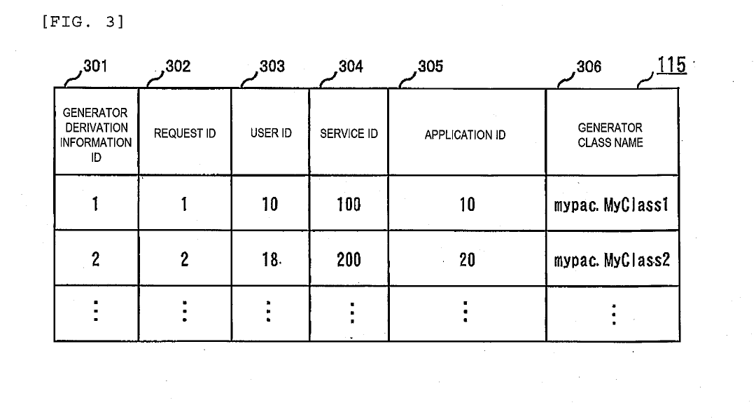

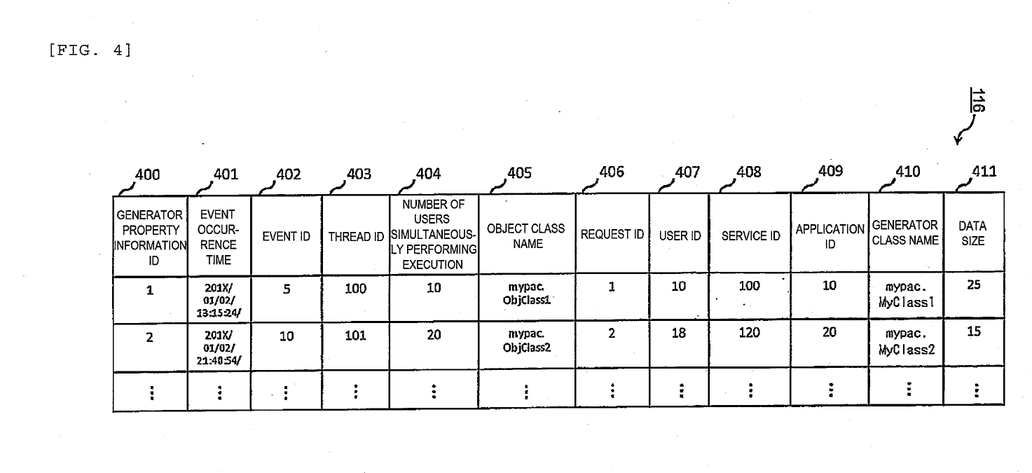

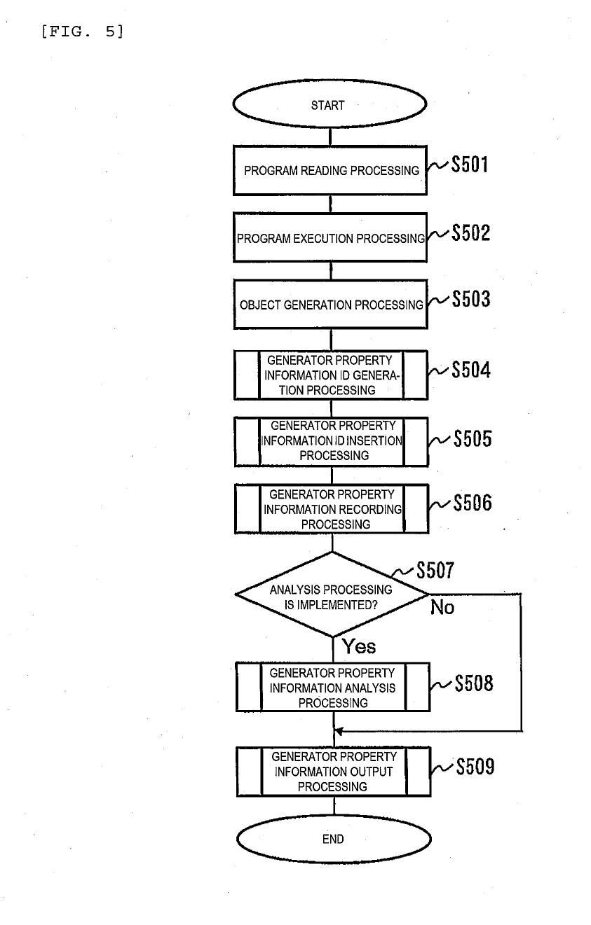

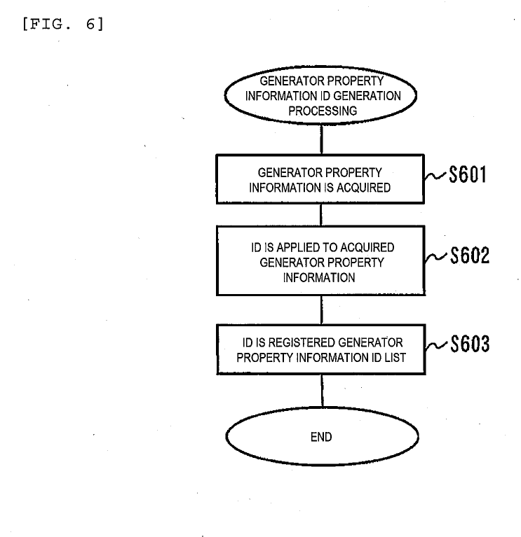

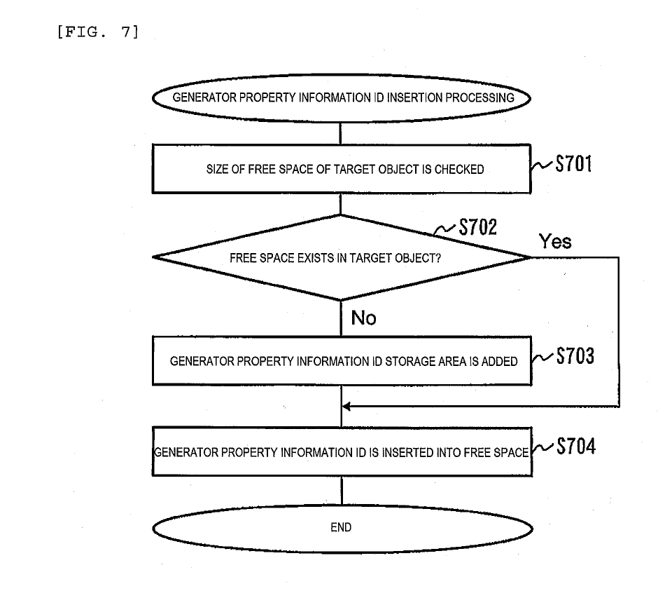

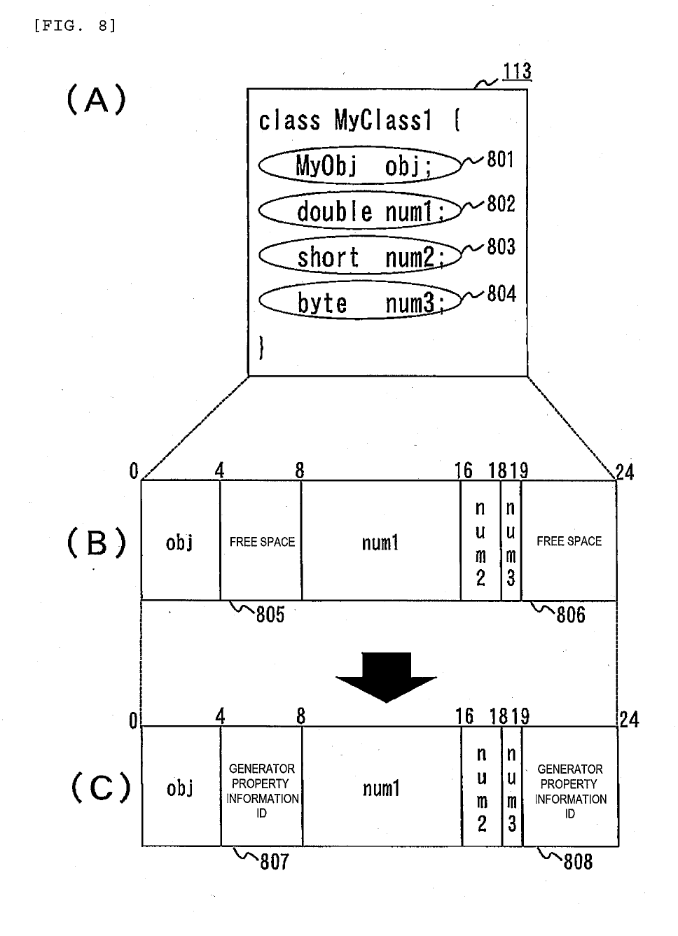

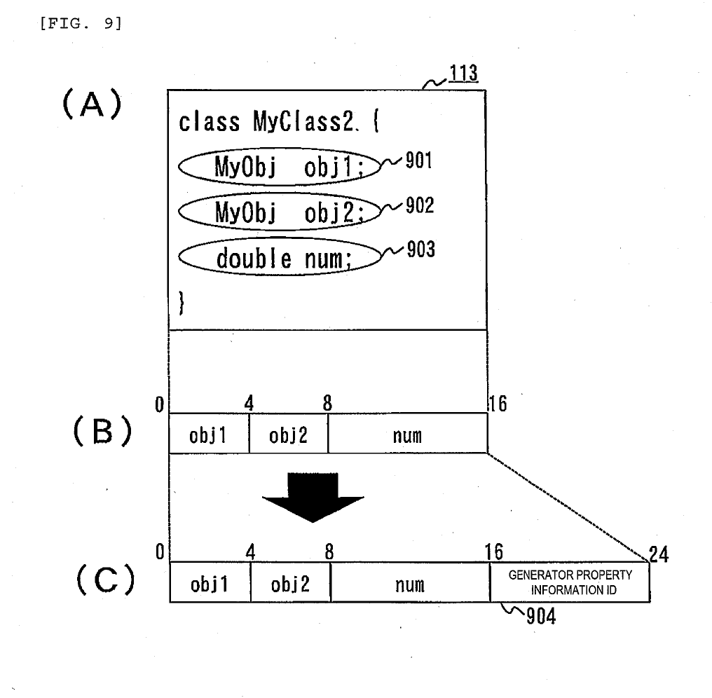

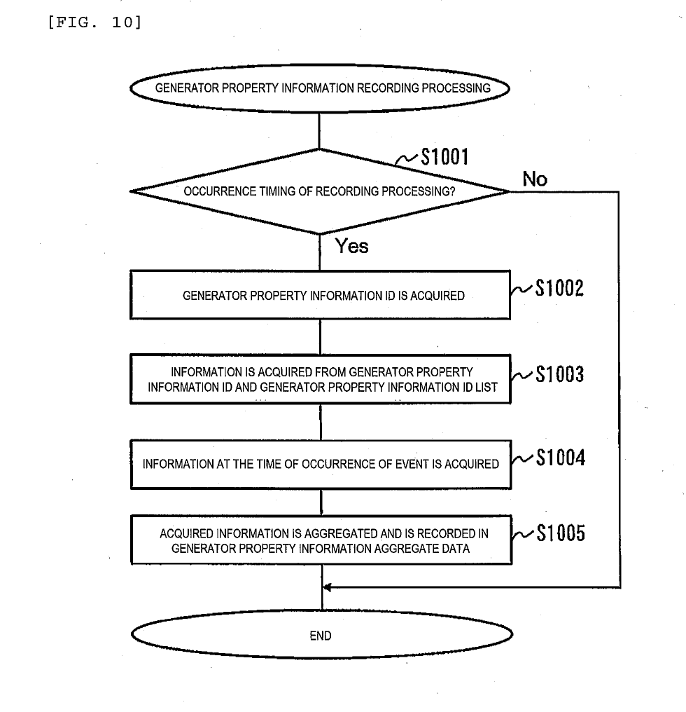

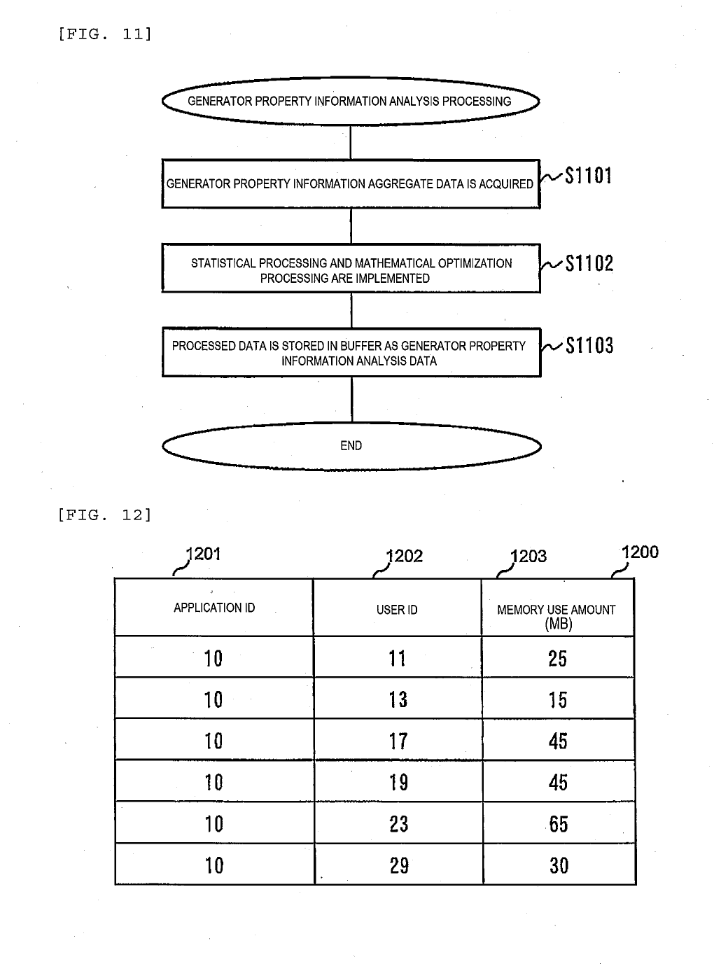

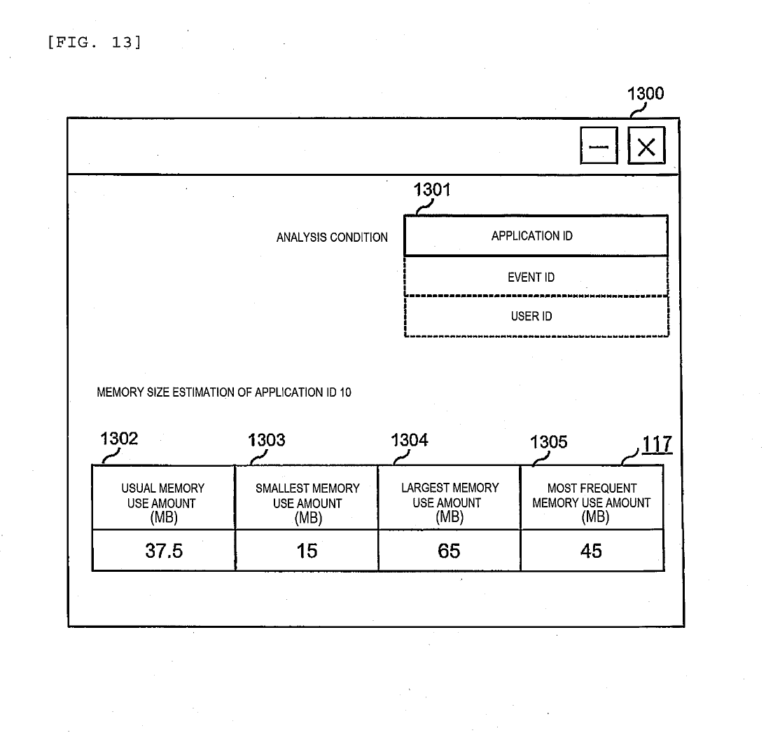

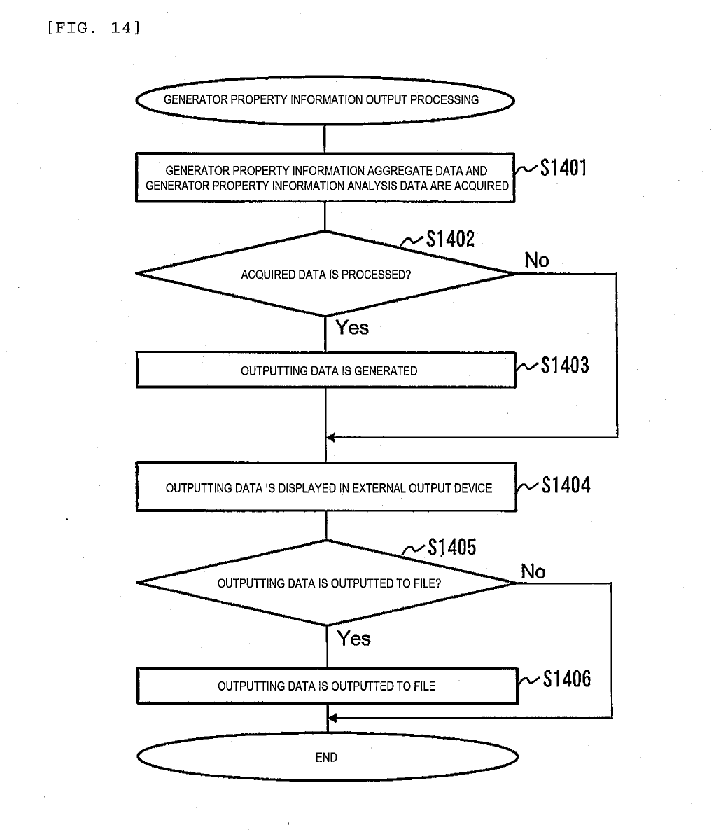

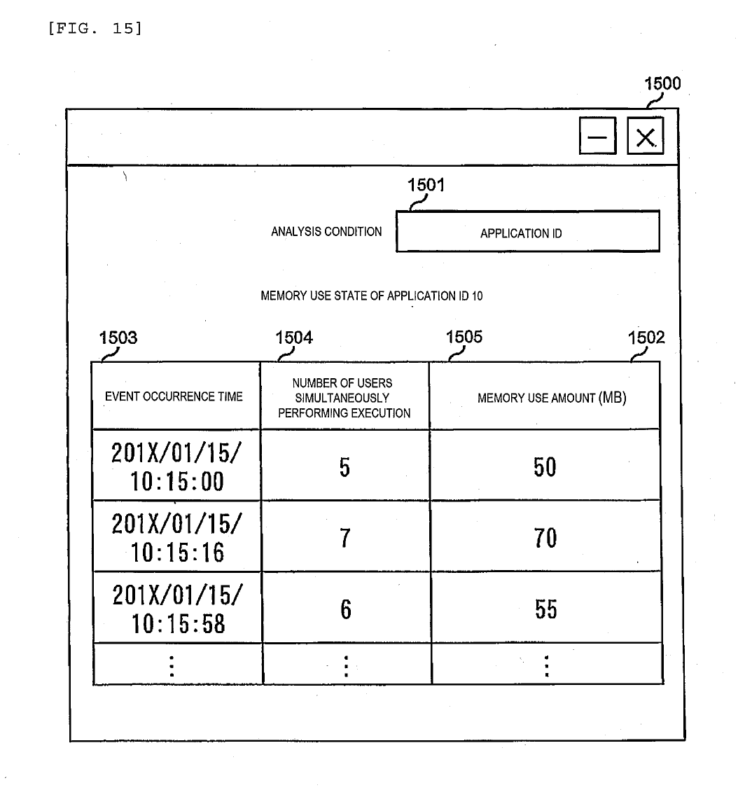

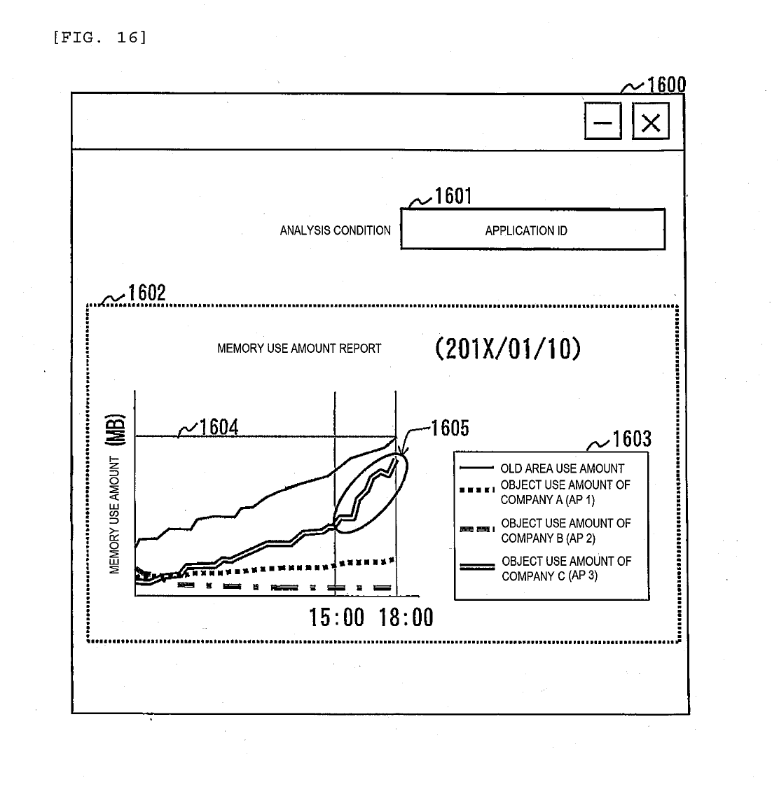

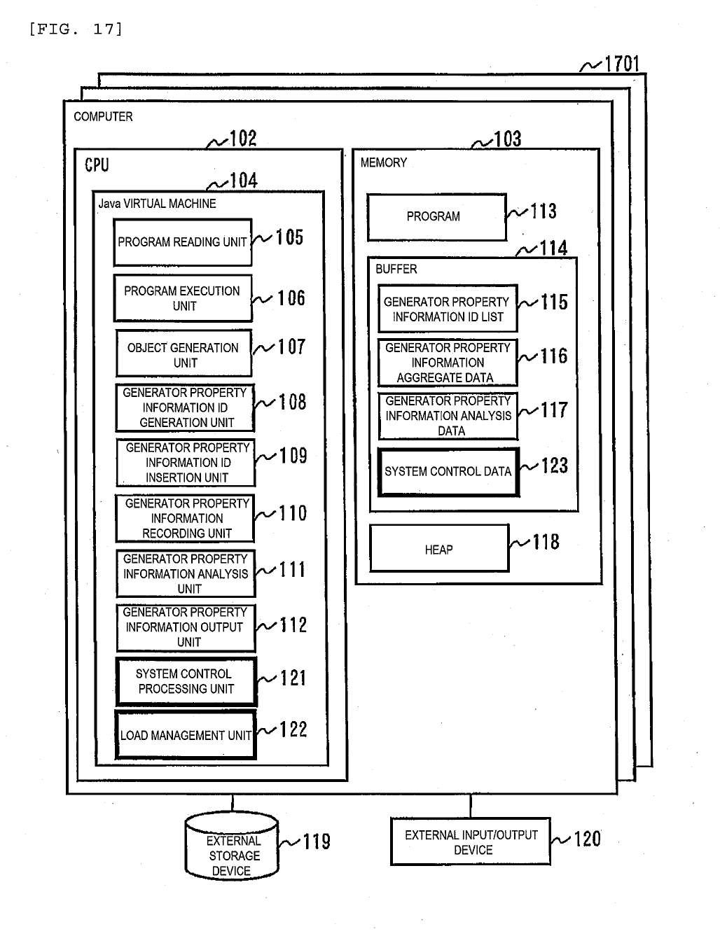

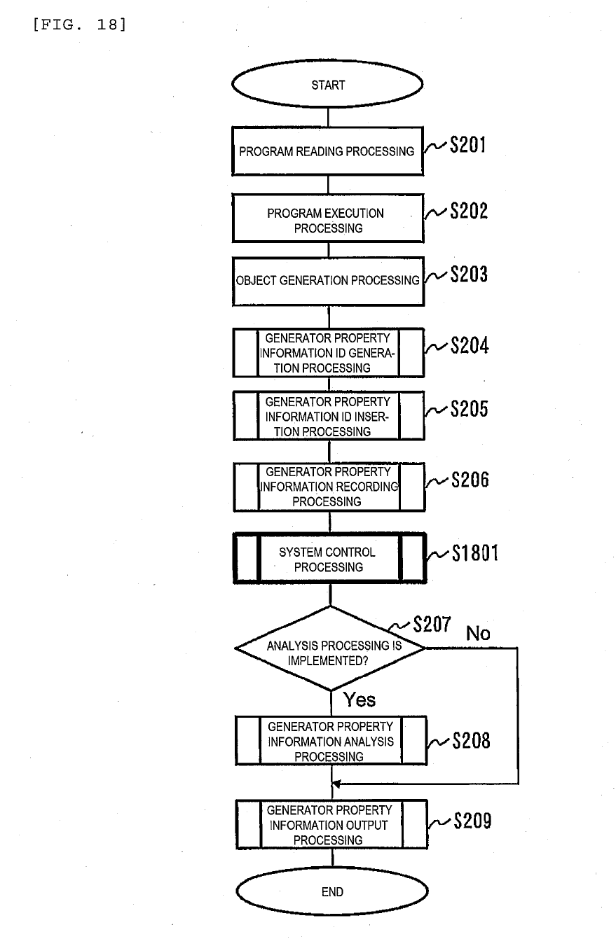

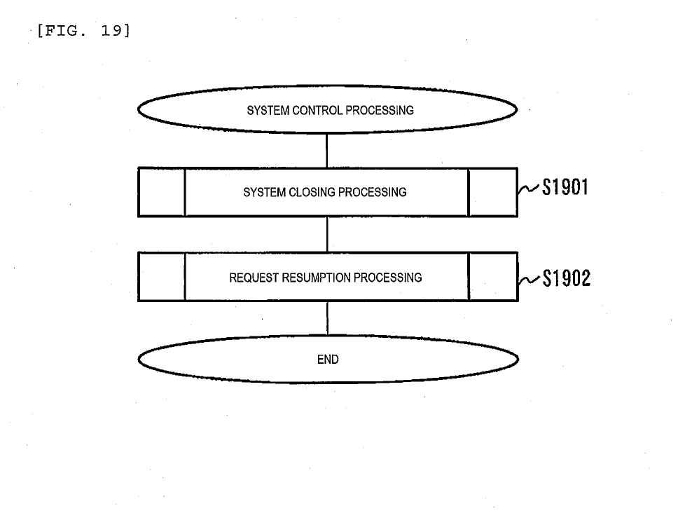

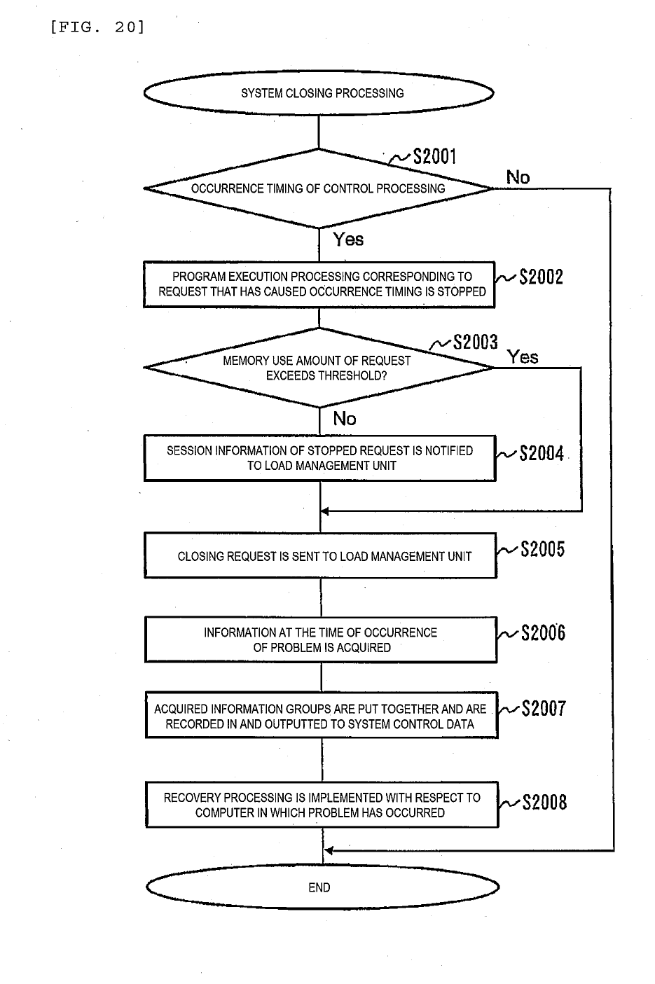

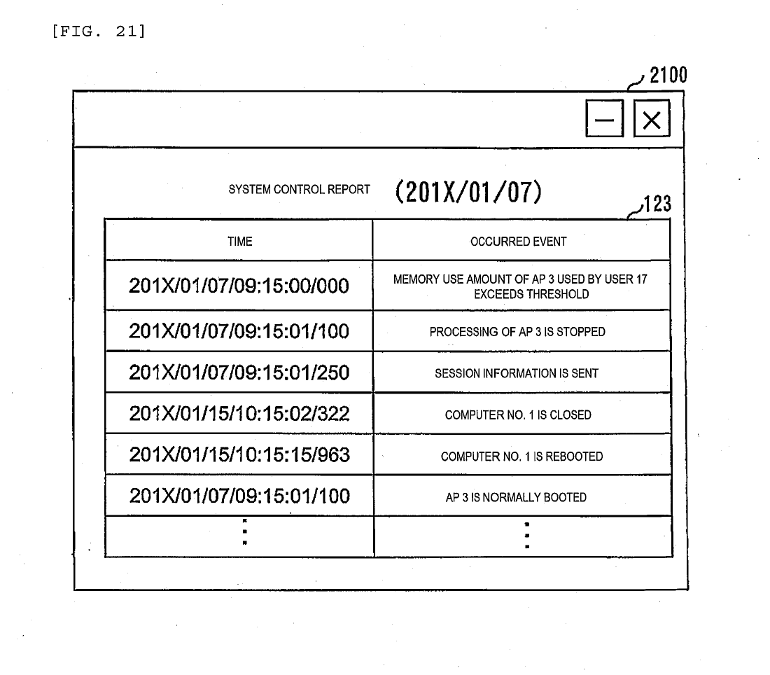

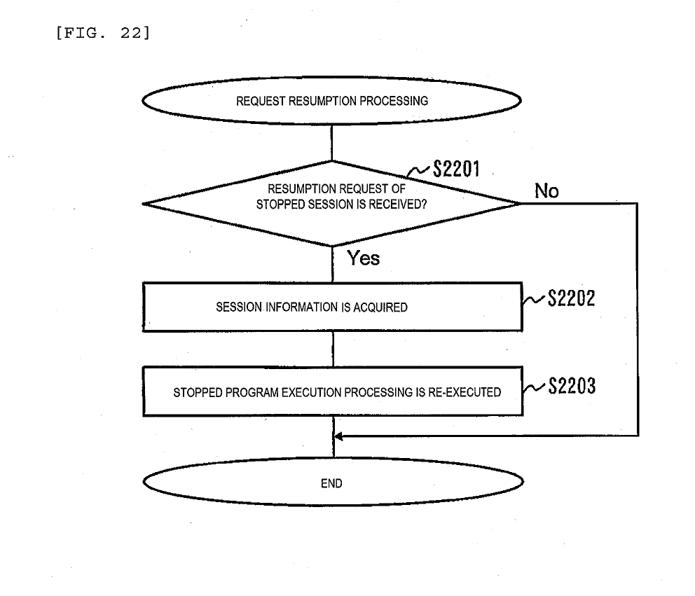

### BRIEF DESCRIPTION OF DRAWINGS

[FIG. 1] FIG. 1 is a view illustrating outline of Embodiment 1 to which the invention is applied.

[FIG. 2] FIG. 2 is a view illustrating an entire configuration of a computer 101 in Embodiment 1.

[FIG. 3] FIG. 3 is a view showing an example of a generator property information ID list 115 in Embodiment 1.

[FIG. 4] FIG. 4 is a view showing an example of generator property information aggregate data 116 in Embodiment 1.

[FIG. 5] FIG. 5 is a flowchart showing an entire flow of processing of a computer 101 in Embodiment 1.

[FIG. 6] FIG. 6 is a flowchart showing a flow of generator property information ID generation processing in Embodiment 1.

[FIG. 7] FIG. 7 is a flowchart showing a flow of generator property information ID insertion processing in Embodiment 1.

[FIG. 8] FIG. 8 is a view illustrating an example of a program 113 in Embodiment 1 and an example where a generator property information ID is inserted into a free space of a data area of the program 113.

[FIG. 9] FIG. 9 is a view illustrating an example of a program 113 in Embodiment 1 and an example where a generator property information ID storage area is provided at an end of a data area of the program 113.

[FIG. 10] FIG. 10 is a flowchart showing a flow of generator property information recording processing in Embodiment 1.

[FIG. 11] FIG. 11 is a flowchart showing a flow of generator property information analysis processing in Embodiment 1.

[FIG. 12] FIG. 12 shows an example of data extracted from generator property information aggregate data 116 in Embodiment 1.

[FIG. 13] FIG. 13 is a view illustrating a screen display example of generator property information analysis data 117 in Embodiment 1.

[FIG. 14] FIG. 14 is a flowchart showing a flow of generator property information output processing in Embodiment 1.

[FIG. 15] FIG. 15 illustrates an example of a display screen of a memory use state of an application in Embodiment 1.

[FIG. 16] FIG. 16 illustrates an example of a display screen of a memory use state for each application in Embodiment 1.

[FIG. 17] FIG. 17 is a view illustrating an entire configuration of a computer 1701 that is Embodiment 2 to which the invention is applied.

[FIG. 18] FIG. 18 is a flowchart showing an entire flow of processing of a computer 1701 in Embodiment 2.

[FIG. 19] FIG. 19 is a flowchart showing a flow of system control processing in Embodiment 2.

[FIG. 20] FIG. 20 is a flowchart showing a flow of system closing processing in Embodiment 2.

[FIG. 21] FIG. 21 is a view illustrating an example of a display screen 2100 of system control data 123 in Embodiment 2.

[FIG. 22] FIG. 22 is a flowchart showing a flow of request resumption processing in Embodiment 2.

### DESCRIPTION OF EMBODIMENTS

FIG. 1 illustrates a schematic view illustrating outline of an embodiment to which the invention is applied and an example of an object and a method of storing generator property information of the object. Note that, in embodiments of the invention, description will be made by citing, as an example, a computer for executing a program with the use of, in particular, Java among object-oriented languages, and thus description will be made by citing a Java object as an example. However, the embodiments can be also applied to other object-oriented languages such as C#. Further, the embodiments are not limited to object languages and can be similarly applied to a computer for executing a program written in a script language such as JRuby or Jython, and an object to be generated is a piece of data.

In this embodiment, as illustrated in a display screen 1, for example, a memory use amount of an object generated for each used application can be grasped with the use of an application ID that is a piece of generator property information. This is realized by storing, in a Java object, the generator property information related to generation of the object such as request-related information, user-related information, and generator information.

The Java object has a mark area 2, a klass area 3, and a data area 4. Generally, a header area means the mark area 2 and the klass area 3. A data area means the data area 4.

### Embodiment 1

Embodiment 1 of a computer 101 to which the invention is applied will be described with reference to drawings. In this embodiment, identification information used for managing a plurality of pieces of generator property information is inserted into an object generated at the time of operation of a program 113 operated in a Java virtual machine 104. Thus, a memory use amount used by each object is calculated for each piece of the generator property information.

FIG. 2 illustrates a configuration of the computer 101 that is Embodiment 1 to which the invention is applied.

The computer 101 includes a CPU 102 and a memory 103. In the CPU 102, a Java virtual machine (Java VM) 104 is executed. By executing the program (application) 113 in the memory, the Java virtual machine 104 realizes a program reading unit 105, a program execution unit 106, an object generation unit 107, a generator property information ID generation unit 108, a generator property information ID insertion unit 109, generator property information recording unit 110, a generator property information analysis unit 111, and a generator property information output unit 112.

The memory 103 has the program 113 stored in the memory 103, a buffer 114, and a heap 118.

The program reading unit 105 reads the program 113 stored in the memory 103.

The program execution unit 106 executes the read program 113.

The object generation unit 107 generates, in the heap 118, an object needed to execute the program 113.

The generator property information ID generation unit 108 manages, with the use of a unique ID, the generator property information acquired during execution of the program 113, such as the request-related information, the user-related information, and program-related information, and registers the generator property information in a generator property information ID list 115.

The generator property information ID insertion unit 109 inserts a generator property information ID into the object.

The generator property information recording unit 110 acquires the generator property information ID from the object, records, in generator property information aggregate data 116, the generator property information ID together with information at the time of occurrence of an event such as an event occurrence time and the number of users simultaneously performing connection, and arranges the generator property information ID and the information at the time of occurrence of the event in the buffer 114.

The generator property information analysis unit 111 performs analysis processing on the generator property information aggregate data.

The generator property information output unit 112 outputs the generator property information aggregate data 116 and generator property information analysis data 117.

The buffer 114 is a storage area for storing the generator property information ID list 115, the generator property information aggregate data 116, and the generator property information analysis data 117.

The generator property information ID list 115 is a table in which the generator property information for each object is managed. FIG. 3 shows an example of the generator property information ID list 115. The generator property information ID list 115 is configured such that a request ID 302, a user ID 303, a service ID 304, an application ID 305, and a generator class name 306 are associated with a generator property information ID 301.

The request ID 302 is a unique ID applied to a request requested for the Java virtual machine 104 by a user.

The user ID 303 is a unique ID assigned to a user who uses the program 113 operated in the Java virtual machine 104.

The service ID 304 is an ID uniquely assigned to a service operated in the Java virtual machine 104. The service means an application group for achieving a purpose that has been determined in advance.

The application ID 305 is an ID uniquely assigned to the program 113 operated in the Java virtual machine 104.

The generator class name 306 is a class name corresponding to a generator of a generated object.

Note that session information, company (organization) information, generator method information of the object, source code information, generation path information of the object, and the like, which are not written in the generator property information ID list 115, may be also managed.

The generator property information aggregate data 116 is a table in which the generator property information is stored. FIG. 4 shows an example of the generator property information aggregate data 116. The generator property information aggregate data 116 has various kinds of information such as request information, user information, event information, and program information. In this embodiment, the generator property information aggregate data 116 has a generator property information ID 400, an event occurrence time 401, an event ID 402, a thread ID 403, the number of users simultaneously performing execution 404, and an object class name 405, and, in addition, has a request ID 406, a user ID 407, a service ID 408, an application ID 409, a generator class name 410, and a data size 411 which are recorded in the generator property information ID list 115.

The event occurrence time 401 means a time at which an event occurs. The event means, for example, occurrence of GC, excessive user accesses, and mass consumption of a memory.

The event ID 402 is an ID of the event, which is generated in accordance with the kind of occurred event.

The thread ID 403 is a thread ID of a thread in which an object to be recorded is generated.

The number of users simultaneously performing execution 404 is the number of accesses to the Java virtual machine 104 at the time of occurrence of the event.

The object class name 405 is a class name of the object to be recorded.

The data size 411 indicates a size of each object.

The generator property information ID 400, the request ID 406, the user ID 407, the service ID 408, the application ID 409, and the generator class name 410 are similar to contents recorded in the generator property information ID list 115.

The generator property information analysis data 117 is a table showing analyzed data of the generator property information. Details thereof will be described below with reference to FIG. 12 and FIG. 13.

The heap 118 is an area for storing arbitrary data that is dynamically secured at the time of execution of the program 113. A Java heap used at the time of execution of the Java virtual machine 104 is included in the heap 118 used in this embodiment. In this embodiment, the Java virtual machine 104 that incorporates generational garbage collection will be described. However, the Java virtual machine 104 in which another memory management method such as Garbage-First (G1) garbage collection is incorporated can be also applied to.

In a case where the Java virtual machine 104 incorporates the generational garbage collection, the Java heap 118 is managed by dividing the Java heap 118 into three areas, i.e., a New generation area (New area), an Old generation area (Old area), and a Permanent area (Perm area). The New area is managed by dividing the New area into two areas, i.e., an Eden area and a Survivor area. By dividing inside the Java heap 118 as described above, the garbage collection can be executed without influencing responsiveness.

Note that the program 113, the generator property information ID list 115, the generator property information aggregate data 116, and the generator property information analysis data 117 may be stored in an external storage device 119 such as a hard disk and a storage, instead of the memory 103. The computer 101 is connected to an external input/output device 120. The external input/output device 120 means a mouse and a keyboard for receiving input from a user, a display to which an analyzed result is outputted, and the like.

With reference to FIG. 5, an entire flow of processing of the computer 101 in this embodiment will be described.

In S501, the program reading unit 105 reads the program 113 stored in the memory 103.

In S502, the program execution unit 106 executes the read program 113.

In S503, the object generation unit 107 generates, in the heap 118, an object needed to execute the program 113.

In S504, the generator property information ID generation unit 108 generates an ID of generator property information acquired during execution of the program 113, such as request-related information, user-related information, program-related information, and generator information, and registers the ID in the generator property information ID list 115.

In S505, the generator property information ID insertion unit 109 inserts the generated generator property information ID into the object.

In S506, the generator property information recording unit 110 acquires the generator property information ID from the object at the time of occurrence of an event such as a time of occurrence of promotion processing of the object, and acquires corresponding generator property information from the generator property information ID list 115 by using the acquired ID as a key. At this time, the information at the time of occurrence of the event, such as the event occurrence time and the number of users simultaneously performing connection, is added as additional information, and the corresponding generator property information and the additional information are stored in the generator property information aggregate data 116. Then, the stored information is arranged in the buffer 114.

In S507, the generator property information analysis unit 111 determines whether to implement analysis processing in order to decide whether to analyze the generator property information aggregate data 116 generated in generator property information recording processing (S506) by using statistical processing or a mathematical optimization technique. In a case where the analysis processing is performed (S507: Yes), in generator property information analysis processing (S508), the statistical processing or the mathematical optimization processing suitable for a purpose of the analysis is implemented by using the generator property information aggregate data 116 as original data, and a result of the analysis is stored as the generator property information analysis data 117 in the buffer 114. In a case where the analysis processing is not performed (S507: No), the processing proceeds to generator property information output processing (S509).

Finally, in S509, the generator property information output unit 112 outputs the generator property information aggregate data 116 and the generator property information analysis data 117.

Hereinafter, each processing shown in FIG. 5 will be described in detail.

With reference to FIG. 6, a flow of generator property information ID generation processing (S504) will be described. In the generator property information ID generation processing, a unique ID is assigned to the generator property information acquired by executing the program 113 and is registered in the generator property information ID list 115.

Firstly, in S601, the generator property information ID generation unit 108 acquires, from the computer 101, the generator property information acquired by executing the program 113.

Subsequently, in S602, a unique generator property information ID is applied to the acquired generator property information.

Subsequently, in S603, the generator property information acquired in S601 and the generator property information ID applied in S602 are associated with each other and are stored as the generator property information ID list 115 in the buffer 114.

With reference to FIG. 7, a flow of generator property information ID insertion processing (S505) will be described. In the generator property information ID insertion processing, the generated generator property information ID is inserted into a free space of the object. This embodiment describes an example where the generator property information ID is inserted into a data area of the object. However, a location into which the generator property information ID is inserted is not limited to the data area and may be any location as long as it is in the object. Generally, a header area of the object is secured at a fixed size depending on an execution environment, and therefore the free space cannot be secured in some cases. Meanwhile, the data area of the object usually has a size larger than that of the header area and the size thereof is variable, and therefore, in some cases, the generator property information ID is suitably inserted into the data area.

Firstly, in S701, the generator property information ID insertion unit 109 checks a size of a free space of a target object.

Subsequently, in S702, the generator property information ID insertion unit 109 determines whether or not a free space exists in a data area of the target object. In a case where the free space does not exist (S702: No), a generator property information ID storage area is added to the target object in S703. In a case where the free space exists in the data area (S702: Yes), the processing proceeds to S704.

Finally, in S704, the generator property information ID insertion unit 109 inserts the generator property information ID into the free space. Note that an upper limit value of a size of the generator property information ID to be inserted may be determined based on the size of the free space of the object.

FIG. 8A, FIG. 8B, and FIG. 8C illustrate an example where the generator property information ID is inserted into the free space of the data area.

In this embodiment, a unit of alignment is set to 8 bytes, and variables are arranged from the top of the data area at a memory address on a byte basis. Generally, the memory has a boundary for each predetermined bytes depending on physical specification such as a processor and a cache line, and it is necessary to arrange data along the boundary. Arranging the data along the boundary is referred to as “alignment”. In a case where the data is arranged against the alignment, the program is adversely affected. For example, the program cannot be executed, or execution efficiency of the program is remarkably reduced.

A class of the program 113 in FIG. 8A has fields of a reference type 801, a double type 802, a short type 803, and a byte type 804, and 4 bytes, 8 bytes, 2 bytes, and 1 byte are allocated to the respective fields in order. When considering 8 byte alignment, the object of the program 113 is arranged as illustrated in FIG. 8B, and a free space 805 and a free space 806 exist. Therefore, an entire free space of the object becomes “4 bytes+5 bytes=9 bytes”.

FIG. 8C illustrates an example where generator property information IDs 807 and 808 are inserted into the free spaces of the free space 805 and the free space 806 of FIG. 8B. In a case where the generator property information ID is divided and stored, by recording inserted addresses, the generator property information ID can be taken out as necessary. Further, the free spaces can be used without any gaps, and therefore use efficiency of the memory in the object is improved.

The free spaces of the data area may be discrete in the memory 103 as in FIG. 8B. Alternatively, there is also a method in which arrangement order of data in the fields held by a class object is changed so that the free spaces become continuous to insert the generator property information ID. In a case where the generator property information ID is inserted into a continuous area, reference processing of the data to the free spaces is omitted, and therefore combination processing of discrete data in the free spaces is unnecessary. This makes it possible to reduce a processing load to access the generator property information.

Note that, in a case of Java, a location of the free space of the data area is determined depending on the arrangement order of the data stored in the class object serving as a model of the object. Therefore, as to information on which location in the object the generator property information is arranged, a free space can be calculated when the class object is loaded in program execution processing (S502). The information on such an arrangement location can be held in the class object or in another data structure.

With reference to FIG. 9A, FIG. 9B, and FIG. 9C, a method of inserting the generator property information ID in a case where the free space does not exist in the data area will be described. The program illustrated in FIG. 9A has fields of a reference type 901, a reference type 902, and a double type 903, and 4 bytes, 4 bytes, and 8 bytes are allocated to the respective fields in order as illustrated in FIG. 9B. As illustrated in FIG. 9B, in a case where the free space does not exist in the data area, there is a method of providing a generator property information ID storage area 904 at an end of the data area as in FIG. 9C. Note that the generator property information ID storage area may be provided in any area as long as it is provided in the area.

In this embodiment, the size of the free space of the object is checked in the program execution processing (S502). Alternatively, a largest free space size can be grasped by checking information on the class object for use in the application in advance. By checking the information in advance, the generator property information ID can be inserted without increasing a size of the object. Further, by calculating a largest value of the generator property information ID, which can be assigned based on the largest free space size, the generator property information ID can be assigned without increasing the size of the object.

With reference to FIG. 10, a flow of the generator property information recording processing (S506) will be described. In the generator property information recording processing, an object whose generator property information need to be subjected to the recording processing is aggregated and is recorded as the generator property information aggregate data 116.

In S1001, the generator property information recording unit 110 determines whether or not there is an occurrence timing of the recording processing to ascertain whether or not the generator property information needs to be recorded. As the occurrence timing of the recording processing, a time of occurrence of an event is considered, such as a time of occurrence of promotion processing of the object, a time of occurrence of garbage collection (GC), and a time when a memory use amount exceeds a threshold that has been set in advance. In a case where there is the occurrence timing of the recording processing (S1001: Yes), the generator property information ID is acquired from the object to be recorded in S1002. In a case where there is no occurrence timing (S1001: No), the processing is terminated.

In S1003, the generator property information recording unit 110 acquires information from the generator property information ID list with the use of the acquired generator property information ID.

In S1004, the generator property information recording unit 110 acquires the information at the time of occurrence of the event related to the generator property information of an object to be recorded. The information at the time of occurrence of the event herein indicates information such as an occurrence time of the event to be recorded, the number of users simultaneously performing connection, and the number of threads at the time of occurrence of the event to be recorded. Herein, whether or not an object is the object to be recorded can be determined by using a reference flag that the object has, but another method may be used.

In S1005, the acquired generator property information and the information at the time of occurrence of the event are aggregated and are stored as the generator property information aggregate data 116 in the buffer 114.

Note that, at the time of such aggregate processing of the generator property information, information on a state of an inflow rate of the object and an existing amount of the object in the areas (Survivor area, Old area, and the like) configuring the heap 118 may be aggregated.

With reference to FIG. 11, a flow of the generator property information analysis processing (S508) will be described. In the generator property information analysis processing, the generator property information aggregate data 116 is analyzed with the statistics and the mathematical optimization technique, and the generator property information analysis data 117 that can be used for prediction and pattern analysis is generated.

In S1101, the generator property information analysis unit 111 acquires the generator property information aggregate. data 116 from the buffer 114.

In S1102, the generator property information analysis unit 111 implements the analysis processing such as the statistical processing and the mathematical optimization processing with respect to the acquired generator property information aggregate data 116. As specific examples of the analysis processing, there are various analysis methods such as prediction of a memory use amount after a predetermine time elapses using probabilistic analysis theory, abnormal use pattern analysis of a program-specific memory use amount with a discriminant analysis method, and operation tendency analysis of users with cluster analysis.

In S1103, the generated data is stored as the generator property information analysis data 117 in the buffer 114.

Herein, as a kind of the analysis processing, a sizing method of a memory will be exemplified.

The application ID, the request ID, and a memory use amount for each request corresponding to the request ID are extracted from the generator property information aggregate data 116 acquired in S1101. FIG. 12 shows an example of data extracted from the generator property information aggregate data 116. Data 1200 is data extracted by using the generator property information of the application ID as an analysis condition, and shows a result of extraction in response to a request in which an application ID 1201 is “10” from the generator property information aggregate data 116. A method of extracting the data can be arbitrarily specified by a user. Although this embodiment describes an example where a user ID 1202 and a memory use amount 1203 are extracted by using the application ID 1201 as the analysis condition, other generator property information can be used as the analysis condition to perform extraction, or a plurality of pieces of the generator property information can be simultaneously extracted.

FIG. 13 illustrates an example of a display screen 1300 displaying the generator property information analysis data 119 that has been subjected to the generator property information analysis processing from the data 1200 of FIG. 12. The display screen 1300 displays an analysis condition specification tag 1301 for specifying which generator property information is used as a condition to analyze the object. A user can arbitrarily select the generator property information serving as the analysis condition with the use of the analysis condition specification tag 1301. The generator property information analysis data 119 has, for example, information such as a usual memory use amount 1302, a smallest memory use amount 1303, a largest memory use amount 1304, and a most frequent memory use amount 1305. The user can grasp a memory use amount needed to execute the application from the display screen 1300. Note that, in this embodiment, a usual memory use amount of a certain application is set as an average value of memory use amounts for respective requests.

With reference to FIG. 14, a flow of the generator property information output processing (S509) will be described. In the generator property information output processing, the generator property information aggregate data 116 and the generator property information analysis data 117 are outputted to the external input/output device 120. Note that data to be outputted may be processed data of the generator property information aggregate data 116 and the generator property information analysis data 117.

In S1401, the generator property information output unit acquires the generator property information aggregate data 116 and the generator property information analysis data 117 from the buffer 114.

In S1402, whether to process the acquired data is determined. In a case where the acquired data is processed (S1402: Yes), the processing proceeds to S1403, and in a case where the acquired data is not processed (S1402: No), the processing proceeds to S1404.

In S1403, outputting data is generated from the generator property information aggregate data 116 and the generator property information analysis data 117. Note that data process in this processing is mainly format conversion for a time when the data is outputted to a screen or outputted to a file. Note that the analysis processing (S1102) of FIG. 11 may be performed in this processing.

In S1404, the outputting data is outputted to the external input/output device 120.

In S1405, whether to output the outputting data to a file in the external storage device 119 is determined. In a case where the outputting data is outputted to a file (S1405: Yes), the data is outputted to the external storage device 119 in S1406. In a case where the outputting data is not outputted (S1405: No), the processing is terminated.

FIG. 15 illustrates a display screen 1500 displaying an example of the outputting data. The display screen 1500 displays a tag 1501 for specifying the analysis condition and outputting data 1502. The outputting data 1502 has, for example, an event occurrence time 1503, the number of users simultaneously performing execution 1504, and a memory use amount 1505. Other generator property information may be displayed.

The outputting data 1502 displays the number of users simultaneously performing execution 1504 with respect to the Java virtual machine 104 and the memory use amount 1505 in each execution of GC. As the memory use amount 1505, any use amount may be displayed, such as the inflow rate of the object to the Old area of the heap 118, the existing amount of the object in the Old area of the heap 118, and a generation amount of the object in the New area of the heap 118. A memory use state may be outputted in a form of a CSV file (Comma-Separated Values file) or the like to the external storage device 119.

FIG. 16, as well as FIG. 15, is a display screen 1600 displaying an example of the outputting data. The display screen 1600 displays a tag 1601 for specifying the analysis condition and outputting data 1602. The outputting data 1602 displays a memory use state for each application operated in the Java virtual machine 104. On the screen, a legend 1603 of a displayed graph and a boundary line 1604 indicating a threshold of the memory use amount are displayed, but other information can be displayed on the screen. A user can recognize system abnormality of an application 3 used by Company C on the basis of sudden rise 1605 of the memory use amount on the display screen 1600. Note that, in a case where the memory use amount exceeds a predetermined threshold, abnormality may be notified to a user by displaying an alert on the display screen 1600.

As described above, by applying the invention, it is possible to grasp a use state of an application server with the use of various analysis conditions.

### Embodiment 2

Embodiment 2 of a computer 1701 to which the invention is applied will be described. Embodiment 2 is an embodiment in which control such as closing of a server and migration of a request are executed based on acquired generator property information in an environment of the plurality of computers 1701.

FIG. 17 illustrates an entire configuration of the computer 1701 in Embodiment 2. A configuration that is different from that of FIG. 2 illustrating the entire configuration of Embodiment 1 will be described below.

In this embodiment, a system control processing unit 121 and a load management unit 122 are provided in the Java virtual machine 104 and a system control data 123 is provided in the buffer 114.

In this embodiment, a system configuration in which the plurality of computers 1701 are connected and each of the computers 1701 includes the load management unit 122 is illustrated. However, any one of the computers 1701 configuring the system may include the load management unit 122, or a load management computer that is communicable to the computers 1701 may be newly provided.

FIG. 18 shows outline of processing in Embodiment 2. Note that processing from S201 to S209 of FIG. 18 are similar to those of FIG. 2, and therefore description thereof will be omitted.

In system control processing in S1801 that is a new processing step, closing processing of a computer 1701 in which a problem has occurred and request resumption processing are implemented.

With reference to FIG. 19, a flow of the system control processing (S1801) will be described.

In S1901, in order to minimize a range of influence of the problem, there is performed system closing processing in which stop processing of a request and closing processing of the computer 1701 in which the problem has occurred are performed.

In S1902, in order to normally process the request migrated from the computer 1701 in which the problem has occurred, the request stopped in the system closing processing (S1901) is re-executed and the processing is terminated.

With reference to FIG. 20, a flow of the system closing processing (S1901) will be described. In the system closing processing, at the time of occurrence of the problem regarding a memory use amount, the request in which the problem has occurred is stopped with the use of a memory use amount for each request, a memory use amount for each application, a memory use amount for each user, a memory use amount for each service, and the like that have been aggregated in generator property information recording processing (S206), and the closing processing of the computer 1701 is performed.

In S2001, the system control processing unit 121 ascertains whether or not there is an occurrence timing of the control processing. In a case where there is the occurrence timing of the control processing (S2001: Yes), the processing proceeds to S2002, and program execution processing corresponding to the request that has caused the occurrence timing is stopped. In a case where there is no occurrence timing of the control processing (S2001: No), the processing is terminated. The occurrence timing of the control processing means, for example, a time of occurrence of Full GC, a time when the memory use amount of the request exceeds a threshold that has been set in advance, and a time when a use amount of the heap 118 exceeds a threshold that has been set in advance.

In S2003, the system control processing unit 121 ascertains whether or not the memory use amount of the program processing corresponding to the request exceeds the threshold that has been set in advance. This is performed to ascertain whether or not the memory use amount of the request corresponding to the stopped program execution processing has an abnormal value. In a case where the memory use amount does not exceed the threshold (S2003: No), in order to perform a re-execution request with respect to another computer 1701 in the system, session information of the stopped request is sent to the load management unit 122 in S2004. In a case where the memory use amount exceeds the threshold (S2003: Yes), the request is considered as an abnormal request, and the processing proceeds to S2005. A closing request of the computer 1701 in which the problem has occurred is sent to the load management unit 122.

In S2006, the system control processing unit 121 acquires information at the time of occurrence of the problem in order to record an occurrence status of the problem.

In S2007, in order to record the information at the time of occurrence of the problem, the system control processing unit 121 puts together the acquired information at the time of occurrence of the problem and a handling history and records the acquired information and the handling history as the system control data 123.

In S2008, the system control processing unit 121 implements recovery processing such as rebooting and garbage collection processing with respect to the computer 1701 in which the problem has occurred.

FIG. 21 illustrates an example of a display screen 2100 displaying an example of the system control data 123. FIG. 21 displays the system control data 123 as a system control report and displays a time of each event and a content of the event. Note that information to be outputted is not limited thereto, and request information, user information, and the like may be displayed. The system control data 123 may output the information in a file form such as a CSV file.

With reference to FIG. 22, a flow of the request resumption processing (S1902) will be described. The request resumption processing is processing in which a normal request stopped in the system control processing is re-executed in another computer 1701.

In S2201, the system control processing unit 121 ascertains whether or not a resumption request of a stopped session is received from the load management unit 122. In a case where the resumption request is received (S2201: Yes), the session information is acquired from the load management unit 122 in S2202. Note that the session information may be acquired directly from the computer 1701 in which the problem has occurred, instead of the load management unit 122. In a case where the resumption request is not received (S2201: No), the processing is terminated.

In S2203, in order to return a result in response to the request, the system control processing unit 121 re-executes the program processing corresponding to the stopped request, and the processing is terminated.

Note that, in this embodiment, the session and the request are migrated to another computer 1701 that is normally operated. However, scale-out processing may be performed on another computer 1701 in a hot standby state, and the session and the request may be migrated to the computer 1701 that has been subjected to the scale-out processing.

By implementing the above processing, even in a case where abnormality occurs in the memory use amount of the computer 1701, it is possible to return the result in response to the request without shutting down the system.

Hereinabove, the embodiments for implementing the invention have been described. However, the invention is not limited to those examples, and various configurations and operations are applicable within the scope of the invention.

An example where function units in the embodiments are realized by cooperating a program and a CPU has been described above, but a part or all thereof can be also realized as hardware.

The information managed while being shown in various table forms in the embodiments is not limited to the table forms. Various kinds of information may be displayed on an operation screen of a client.

Note that a program for realizing the function units in the embodiments can be stored in an electrical.electronic and/or magnetic non-transitory recording medium.

### REFERENCE SIGNS LIST

101 . 1701 . . . computer
102 . . . CPU
103 . . . memory
104 . . . Java virtual machine
105 . . . program reading unit
106 . . . program execution unit
107 . . . object generation unit
108 . . . generator property information ID generation unit
109 . . . generator property information ID insertion unit
110 . . . generator property information recording unit
111 . . . generator property information analysis unit
112 . . . generator property information output unit
113 . . . program
114 . . . buffer
115 . . . generator property information ID list
116 . . . generator property information aggregate data
117 . . . generator property information analysis data
118 . . . heap
119 . . . external storage device
120 . . . external input/output device
121 . . system control processing unit
122 . . . load management unit
123 . . . system control data

1. A method of managing a memory, wherein a computer for executing a program to generate data executes
a step of specifying, from a storage device in which a plurality of pieces of generator property information on the data and identification information that the data has are associated and held, data corresponding to each piece of the generator property information and calculating a memory use amount of the specified data, and
a step of outputting the calculated memory use amount to an interface.

2. The method of managing the memory according to claim 1, wherein:
a data structure of the data has a control area for storing information on control of the data and a data area; and
the computer executes a step of inserting the identification information into the data area.

3. The method of managing the memory according to claim 2, wherein the generator property information has at least one of program information indicating definition of the data, request information on generation of the data, information on a user executing the program, and information on an event instructed by the program.

4. The method of managing the memory according to claim 3, wherein:
the memory has a plurality of areas; and
the computer calculates the memory use amount by using, as a timing, at least one of a phenomenon in which the data is generated by execution of the program, a phenomenon in which, in response to occurrence of garbage collection instructing freeing of the memory, the data is migrated to a memory area that is different from an area in which the freeing has been instructed, and a phenomenon in which the memory use amount is equal to or larger than a threshold.

5. The method of managing the memory according to claim 3, wherein the computer executes
a step of performing statistical processing or optimization processing regarding the memory use amount with the use of the memory use amount, and
a step of outputting a result of the statistical processing or the optimization processing to the interface.

6. A computer for executing a program to generate data, comprising:
an insertion unit for inserting identification information that the data has into a data structure of the data;
a storage unit for holding a plurality of pieces of generator property information on the data and the identification information which are associated with each other;
an analysis unit for specifying data corresponding to each piece of the generator property information on the basis of the identification information and calculating a memory use amount of the specified data; and
an output unit for outputting the memory use amount.

7. The computer according to claim 6, wherein:
a data structure of the data has a control area for storing information on control of the data and a data area; and
the insertion unit inserts the identification information into the data area.

8. The computer according to claim 7, wherein the generator property information has at least one of program information indicating definition of the data, request information on generation of the data, information on a user executing the program, and and information on an event instructed by the program.

9. The computer according to claim 8, wherein:
the memory has a plurality of areas; and
the analysis unit calculates the memory use amount by using, as a timing, at least one of a phenomenon in which the data is generated by execution of the program, a phenomenon in which, in response to occurrence of garbage collection instructing freeing of the memory, the data is migrated to a memory area that is different from an area in which the freeing has been instructed, and a phenomenon in which the memory use amount is equal to or larger than a threshold.

10. The computer according to claim 8, wherein:
the analysis unit further performs statistical processing or optimization processing regarding the memory use amount with the use of the memory use amount; and
the output unit outputs a result of the statistical processing or the optimization processing.

11. A non-transitory computer readable recording medium storing a program for causing a computer for executing a program to generate data to execute
a step of holding a plurality of pieces of generator property information on the data and identification information that the data has so that the plurality of pieces of generator property information and the identification information are associated with each other,
a step of specifying data corresponding to each piece of the generator property information and calculating a memory use amount of the specified data, and
a step of displaying the calculated memory use amount.
